(19) United States
(12) Patent Application Publication
(10) Pub. No.: US 2013/0285915 A1
(43) Pub. Date: Oct. 31, 2013

(54) IMAGE DISPLAY SYSTEM

(71) Applicant: WISTRON CORP., New Taipei City (TW)

(72) Inventors: Chih-Li Wang, New Taipei City (TW); Mu-Hua Hsu, New Taipei City (TW); Chien-Yuan Hsiao, New Taipei City (TW)

(73) Assignee: WISTRON CORP., New Taipei City (TW)

(21) Appl. No.: 13/720,803

(22) Filed: Dec. 19, 2012

(30) Foreign Application Priority Data
Apr. 26, 2012 (TW) 101207795

(51) Int. Cl. G02F 1/1335; G06F 3/02

(52) U.S. Cl. CPC G02F 1/133528; G06F 3/02
USPC 345/168; 349/62

(57) ABSTRACT

An image display system is provided. Shutter glasses have a first active polarizer, determining whether the first active polarizer has a first polarization direction or not according to a display mode. A display apparatus has a second active polarizer determining whether the second active polarizer has a second polarization direction or not according to the display mode, and a bottom polarizer with a third polarization direction. When the display mode is a normal mode, the first active polarizer has no polarization, and the second active polarizer has the second active polarizer being perpendicular to the third polarization direction. When the display mode is a safe mode, the second active polarizer has no polarization, and the first active polarizer has the first active polarizer being perpendicular to the third polarization direction.

### CROSS REFERENCE TO RELATED APPLICATIONS

This Application claims priority of Taiwan Patent Application No. 101207795, filed on Apr. 26, 2012, the entirety of which is incorporated by reference herein.

### BACKGROUND OF THE INVENTION

1. Field of the Invention

The disclosure relates generally to image systems, and more particularly relates to image systems with active polarizers.

2. Description of the Related Art

Due liquid crystal displays having advantages of high definition, small sizes, light weights, and various applications, they are commonly used in electrical devices such as mobile phones, notebooks, desktop displays, and televisions. Liquid crystal displays have replaced traditional cathode-ray tube (CRT) displays, and are now the most popular type of displays used. Nowadays, electrical devices, such as notebooks, PDAs or mobile phones, provide viewing information to users using liquid crystal displays, in general. However, users sometime need to read private information in public, or show information on a display only to a select group of people. In order to keep the information private, a device preventing undesired viewers from viewing a display is required.

### BRIEF SUMMARY OF THE INVENTION

In an embodiment, an image display system comprises shutter glasses and a display apparatus. The shutter glasses have a first active polarizer determining whether the first active polarizer has a first polarization direction according to a display mode. The display apparatus outputs an image, and comprises a second active polarizer, a liquid crystal layer, a bottom polarizer, and a backlight unit. The second active polarizer determines whether the second active polarizer has a second polarization direction according to the display mode. The bottom polarizer has a third polarization direction. The backlight unit generates a backlight, wherein the image is outputted by the backlight passing through the bottom polarizer, the liquid crystal layer, and the second active polarizer in order. When the display mode is a normal mode, the first active polarizer has no polarization, and the second active polarizer has the second polarization direction being perpendicular to the third polarization direction. When the display mode is a safe mode, the second active polarizer has no polarization, and the first active polarizer has the first active polarizer being perpendicular to the third polarization direction.

In an embodiment, an image display system comprises shutter glasses and a display apparatus. The shutter glasses have a first active polarizer with a first polarization direction, and the first active polarizer determines the first polarization direction according to a display mode. The display apparatus outputs an image, wherein the display apparatus comprises a second active polarizer, a liquid crystal layer, a bottom polarizer, and a backlight unit. The second active polarizer having a second polarization direction, wherein the second active polarizer determines the second polarization direction according to the display mode. The bottom polarizer has a third polarization direction. The backlight unit generates a backlight, wherein the image is outputted by the backlight passing through the bottom polarizer, the liquid crystal layer, and the second active polarizer in order. When the display mode is a normal mode, the second polarization direction is perpendicular to the third polarization direction. When the display mode is a safe mode, an included acute angle between the second polarization direction and the third polarization direction is smaller than an included acute angle between the first polarization direction and the second polarization direction.

### BRIEF DESCRIPTION OF DRAWINGS

The invention will become more fully understood by referring to the following detailed description with reference to the accompanying drawings, wherein:

FIG. 1 is a schematic diagram illustrating an embodiment of an image system;

FIG. 2 is an explosive view of an embodiment of the image system 100 shown in FIG. 1;

FIG. 3 is a schematic diagram illustrating another embodiment of an image system; and

FIG. 4 is an explosive view of an embodiment of the image system shown in FIG. 3.

### DETAILED DESCRIPTION OF THE INVENTION

The making and using of the embodiments of the present invention are discussed in detail below. It should be appreciated, however, that the embodiments provide many applicable inventive concepts that can be embodied in a wide variety of specific contexts. The specific embodiments discussed are merely illustrative of specific ways to make and use the invention, and do not limit the scope of the invention.

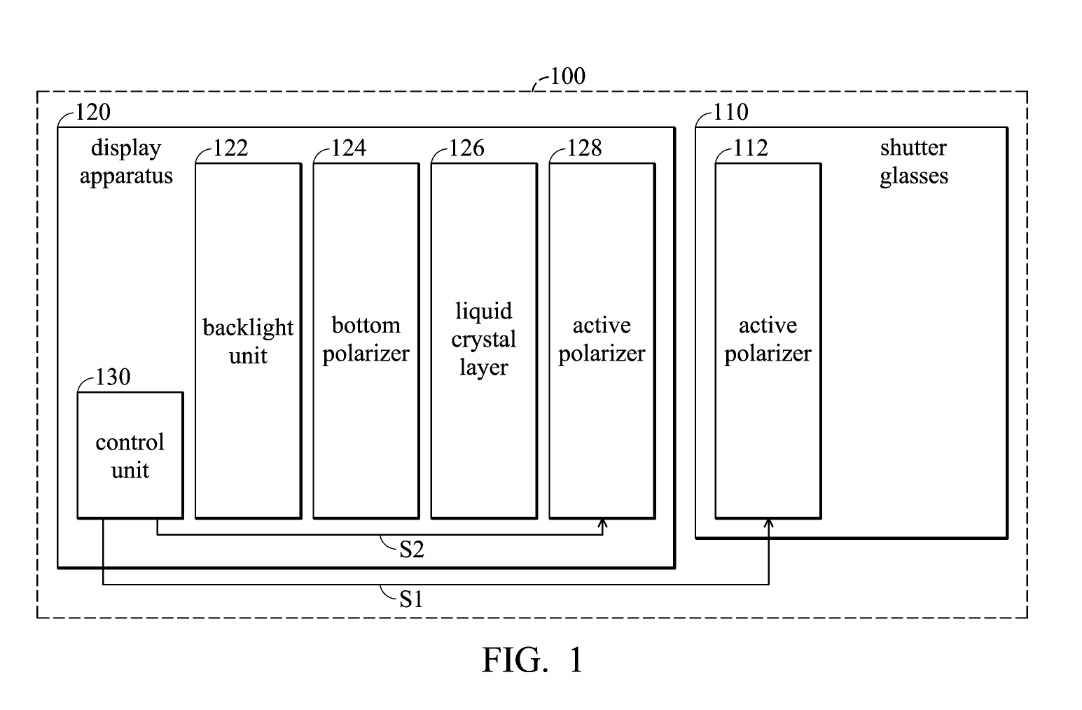

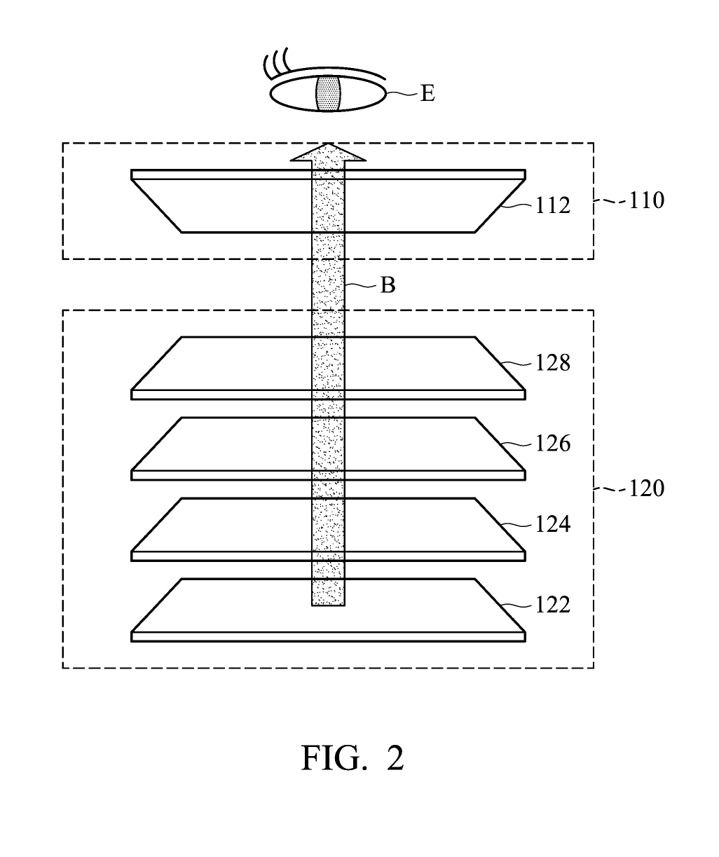

FIG. 1 is a schematic diagram illustrating an embodiment of an image system. The image system comprises shutter glasses 110 and a display apparatus 120. The shutter glasses 110 comprise an active polarizer 112. The display apparatus 120 comprises a backlight unit 122, a bottom polarizer 124, a liquid crystal layer 126, an active polarizer 128, and a control unit 130. Referencing the backlight direction B shown in FIG. 2, the backlight generated by the backlight unit 122 passes through the bottom polarizer 124, the liquid crystal layer 126, and the second active polarizer 128 in order, such that an image is outputted accordingly. Also, the user E views the outputted image via the active polarizer 112 of the shutter glasses 110. Note that, the active polarizers 112, and 128 can change their polarization directions to allow the light with the same polarization direction to pass therethrough. Therefore, the light is polarized with the polarization direction changed by the active polarizers 112, and 128.

In some embodiments of the invention, a display mode of the image system 100 comprises a normal mode and a safe mode. When the display mode of the image system 100 is the normal mode, the active polarizer 128 changes its polarization direction to be perpendicular to the polarization direction of the bottom polarizer 124. For example, the display apparatus 120 may be an In Panel Switching (ISP) type liquid crystal display apparatus or Vertical Alignment (VA) type liquid crystal display apparatus. If the polarization direction of the bottom polarizer 124 is a horizontal direction, the active polarizer 128 sets its polarization direction to be a vertical direction when in the normal mode. Otherwise, if the polarization direction of the bottom polarizer 124 is 45 degrees, like that for a common liquid crystal display apparatus, the active polarizer 128 sets its polarization direction to be 135 degrees when in the normal mode. At this time, the polarization direction of the bottom polarizer 124 is perpendicular to the polarization direction of the active polarizer 128. Therefore, the outputted image of the display apparatus 120 is clear, when the backlight generated by the backlight unit 122 has been polarized via the bottom polarizer 124, twisted by molecules of the liquid crystal layer 126, and passed through the active polarizer 128. During this time, everyone can clearly view the image outputted by the display apparatus 120.

When the display mode of the display system 100 is a normal mode, everyone can clearly view the image outputted by the display apparatus 120. Thus, in an embodiment of the present invention, the active polarizer 112 of the shutter glasses 110 may have no polarization. Namely, any polarization of lights can pass through the active polarizer 112. Also, the active polarizer 112 of the shutter glasses 110 can change the polarization direction to be the same as the active polarizer 128, so that a user E with the shutter glasses 110 can view the clear image outputted by the display apparatus 120.

In an embodiment of the present invention, when the display mode of the display system 100 is the safe mode, the active polarizer 128 of the display apparatus 120 sets the active polarizer 128 to have no polarization, and the active polarizer 112 of the shutter glasses 110 adjusts its polarization direction to be perpendicular to the polarization direction of the bottom polarizer 124. For example, if the polarization direction of the bottom polarizer 124 is a horizontal direction, the active polarizer 112 of the shutter glasses 110 sets its polarization direction to be a vertical direction when in the normal mode. Otherwise if the polarization direction of the bottom polarizer 124 is 45 degrees like that for a common liquid crystal display apparatus, the active polarizer 112 of the shutter glasses 110 sets its polarization direction to be a 135 degrees when in the normal mode. At this time, when the backlight generated by the backlight unit 122 has been polarized via the bottom polarizer 124, twisted by molecules of the liquid crystal layer 126, and passed through the active polarizer 128, the outputted image of the display apparatus 120 is not clear, because the active polarizer 128 has no polarization. In other words, a user without the shutter glasses 110 cannot clearly view the image on the display apparatus 120. On the other hand, because the active polarizer 112 of the shutter glasses 110 changes its polarization direction to be perpendicular to the polarization direction of the bottom polarizer 124, the image viewed by users is clear after the image outputted by the display apparatus 120 in the safe mode passes through the active polarizer 112 of the shutter glasses 110. Therefore, the user E wearing the shutter glasses 110 can clearly view the image outputted by the display apparatus 120.

It should be noted that although the embodiments above disclose the polarization direction of the active polarizer 112 of the shutter glasses 110 is perpendicular to the polarization direction of the bottom polarizer 124, and the polarization direction of the active polarizer 128 of the display apparatus 120 is perpendicular to the polarization direction of the bottom polarizer 124, the angle error is permissible in the embodiments of the present invention. For example, when the display mode of the image display system 100 is a safe mode, the included angle between the polarization direction of the active polarizer 128 and the polarization direction of the bottom polarizer 124 can be adjusted as sharpness angle (less than 90 degrees). For example, if the polarization direction of the bottom polarizer 124 is a horizontal direction, the included angle between the polarization direction the active polarizer 128 of the display apparatus 120 and horizontal direction can be set as 10 degree angle. At this time, when the backlight generated by the backlight unit 122 has been polarized via the bottom polarizer 124, twisted by molecules of the liquid crystal layer 126, and passed through the active polarizer 128, the outputted image of the display apparatus 120 is not clear, because the polarization direction of the active polarizer 128 of the display apparatus 120 is not precisely perpendicular to the polarization direction of the bottom polarizer 124. Therefore, the user without the shutter glasses 110 cannot clearly view the image outputted by the display apparatus 120. Also, in this embodiment, the active polarizer 112 of the shutter glasses 110 controls the polarization direction of the active polarizer 112 to make an included angle between the polarization direction of the active polarizer 112 and the polarization direction of the bottom polarizer 124 closer to a 90 degree angle (such as an 80 degree angle) in comparison with the included angle between the polarization direction of the active polarizer 128 and the polarization direction of the bottom polarizer 124. Therefore, in comparison with the user not wearing the shutter glasses 110, the user E wearing the shutter glasses 110 can more clearly view the image outputted by the display apparatus 120.

In order to decrease the moire pattern, in an embodiment of the present invention, the polarization direction of the bottom polarizer 124 can have a deflection angle (e.g. a 7 degree angle) to a horizontal direction, and the polarization direction of the active polarizer 128 can have the same deflection angle to a vertical direction, such that the polarization direction of the active polarizer 128 can be perpendicular to the polarization direction of the bottom polarizer 124.

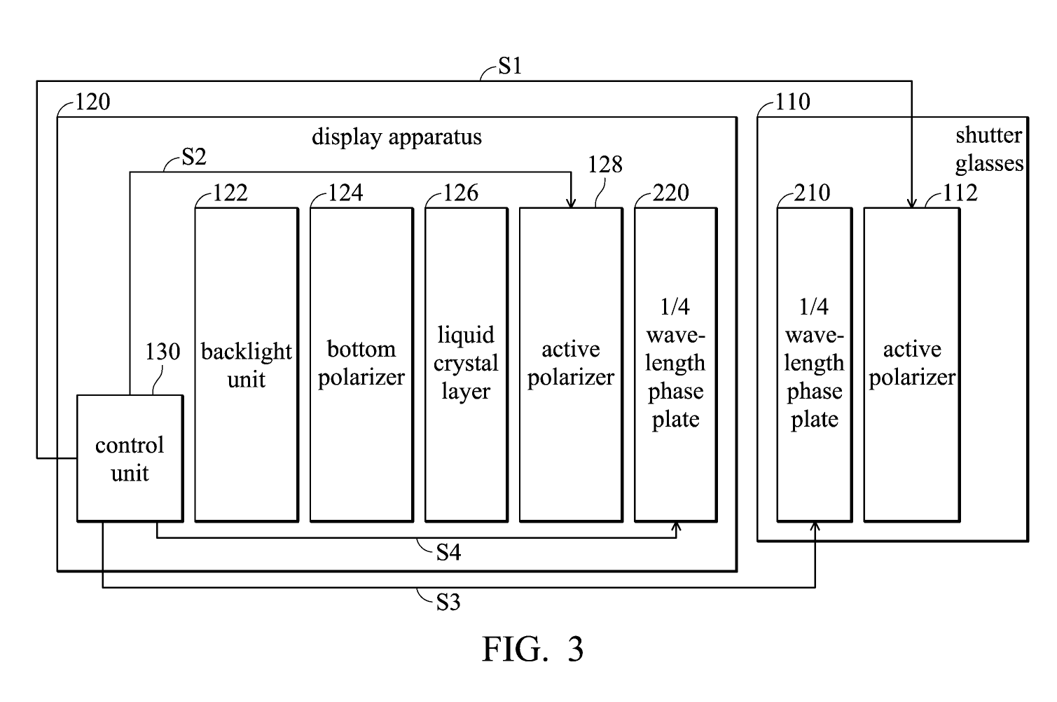

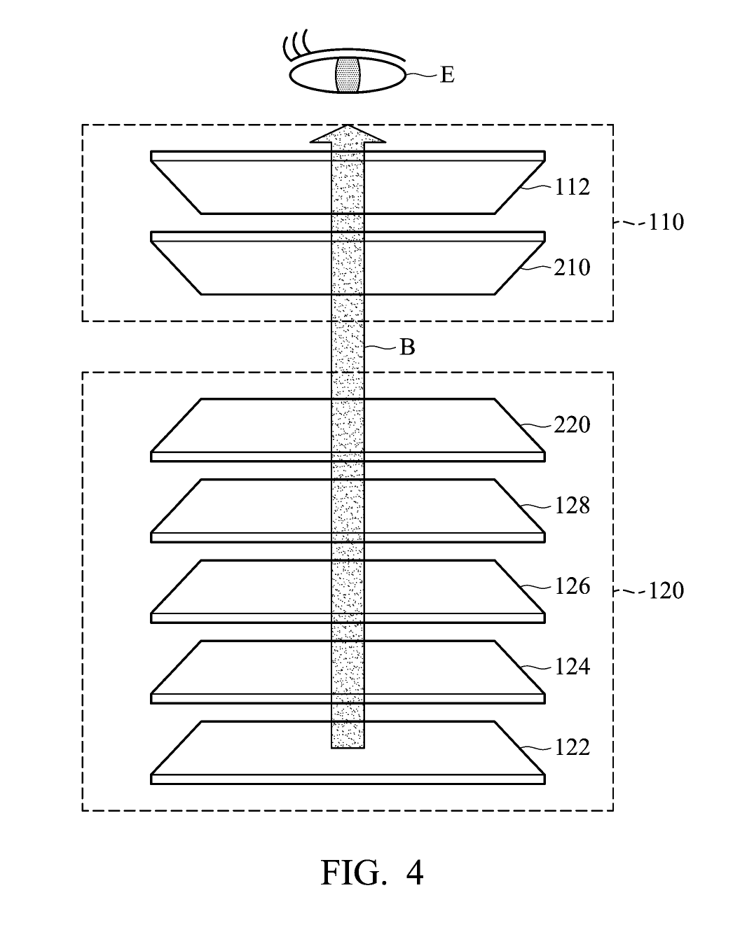

In some embodiments, in order to prevent the users whom are not wearing the shutter glasses 110 from viewing the image outputted by the display apparatus 120, the shutter glasses 110 further comprises a ¼ wave-length phase plate 210 with an adjustable optic axis, and the display apparatus 120 further comprises a ¼ wave-length phase plate 220 with an adjustable optic axis, as shown in FIG. 3. The backlight generated by the backlight unit 122 passes through the bottom polarizer 124, the liquid crystal layer 126, the active polarizer 128, and the ¼ wave-length phase plate 220 in order, such that an image is outputted accordingly. The user E views the outputted image via the active polarizer 112 and the ¼ wave-length phase plate 210 of the shutter glasses 110, as shown with the backlight direction B shown in FIG. 4. In some embodiments, the ¼ wave-length phase plates 210 and 220 with adjustable optic axes can be performed by smart films, and the smart films can determine axis directions D1 and D2 of the optical axes according to the display mode of the display system 100. For example, when the display mode of the display system 100 is the normal mode, a direction of the optical axis of the ¼ wave-length phase plate 210 of the display apparatus 120 is set as a horizontal direction, so that a user E can clearly view the image outputted by the display apparatus 120 via the ¼ wave-length phase plate 210. On the other hand, when the display mode of the display system 100 is the safe mode, a direction of the optical axis of the ¼ wave-length phase plate 210 of the display apparatus 120 is set at 45 degrees to a horizontal direction of the active polarizer 128, so that other users can not clearly view the image outputted by the display apparatus 120. Also, in the safe mode, a direction of the ¼ wave-length phase plate 220 of the shutter glasses 110 can be set to be perpendicular to the direction of the optical axis of the ¼ wave-length phase plate 210, such that ¼ wave-length deflection is obtained after the image passing through the ¼ wave-length phase plate 220 and 210. Therefore, the user E wearing the shutter glasses 110 would not be able to clearly view the image outputted by the display apparatus 120.

In some embodiments, the control unit 130 may transmit a first deflection signal S1 and a second deflection signal S2 to the active polarizer 112 and the active polarizer 128, respectively, according to the display mode set by a user. When the active polarizer 112 and the active polarizer 128 receive the first deflection signal S1 and second deflection signal S2, respectively, the active polarizer 112 and the active polarizer 128 change their the polarization directions according to the first deflection signal Si and the second deflection signal S2. Similarly, in the embodiment of the ¼ wave-length phase plate 210 and 220, the control unit 130 may transmit a third deflection signal S3 and a fourth deflection signal S4 to a first smart film and a second smart film (¼ wave-length phase plate), respectively, according to the display mode set by a user. Then, the first smart film and the second smart film change their directions of optical axes according to the third deflection signal S3 and the fourth deflection signal S4.

In some embodiments, in order to renew the direction of polarization direction of the active polarizer 112 and the active polarizer 128, the control unit 130 may periodically transmit the first deflection signal S1 and the second deflection signal S2 to the active polarizer 112 and the active polarizer 128, respectively. Also, in order to renew the direction of the optical axes of the first smart film and the second smart film, the control unit 130 may periodically transmit the third deflection signal S3 and the fourth deflection signal S4 to a first smart film and a second smart film. In some embodiments, the control unit can be performed by a Keyboard Controller or an Embedded Controller. Therefore, a user can switch the modes of the image display system 100 via a keyboard.

Furthermore, although there is a pair of shutter glasses in the embodiments above, the image display system may still comprise many pairs of shutter glasses 110, and a user can control each pair of shutter glasses 110 via the control unit 130. For example, when the display mode of the image display system 100 is the safe mode, a portion of the pairs of shutter glasses 110 is controlled by changing their active polarizer 112 to be perpendicular to the polarization direction of the bottom polarizer 124 or changing the direction of the optical axis of the ¼ wave-length phase plate 220 to be perpendicular to the direction of the optical axis of ¼ wave-length phase plate 210 of the display apparatus 120, such that the ¼ wave-length deflection is obtained after the image on the active polarizer 128 passes through the ¼ wave-length phase plates 220 and 210. Meanwhile, the other portions of the pairs of shutter glasses 110 may be set to have no polarization. Therefore, it accomplishes determining which user can view the image outputted by the display apparatus 120.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An image display system, comprising:
shutter glasses, having a first active polarizer determining whether the first active polarizer has a first polarization direction according to a display mode; and
a display apparatus, outputting an image, wherein the display apparatus comprises:
a second active polarizer determining whether the second active polarizer has a second polarization direction according to the display mode;
a liquid crystal layer;
a bottom polarizer having a third polarization direction; and
a backlight unit, generating a backlight, wherein the image is outputted by the backlight passing through the bottom polarizer, the liquid crystal layer, and the second active polarizer in order,
wherein when the display mode is a normal mode, the first active polarizer has no polarization, and the second active polarizer has the second polarization direction being perpendicular to the third polarization direction, and
wherein when the display mode is a safe mode, the second active polarizer has no polarization, and the first active polarizer has the first active polarizer being perpendicular to the third polarization direction.

2. The image display system of claim 1, wherein when the display mode is the safe mode, a sharpness of the image passing through the shutter glasses is clearer than a sharpness of the image.

3. The image display system of claim 1, wherein the display device further comprises:
a second ¼ wave-length phase plate having a second optical axis on a second direction, wherein the second active polarizer is arranged between the second ¼ wave-length phase plate and the liquid crystal layer.

4. The image display system of claim 3, wherein the shutter glasses further comprises:
a first ¼ wave-length phase plate having a first optical axis on a first direction, wherein the first direction is perpendicular to the second direction.

5. The image display system of claim 1, wherein the display apparatus further comprises:
a control unit generating a first deflection signal and a second deflection signal according to the display mode.

6. The image display system of claim 5, wherein the control unit is a keyboard controller determining the display mode according to an input via a user keyboard.

7. The image display system of claim 5, wherein the first active polarizer of the shutter glasses further receives the first deflection signal, and the first active polarizer determines the first polarization direction according to the first deflection signal.

8. The image display system of claim 5, wherein the second active polarizer of the display apparatus further receives the second deflection signal, and the second active polarizer determines the second polarization direction according to the second deflection signal.

9. The image display system of claim 5, wherein the control unit renews the first deflection signal and the second deflection signal in a predetermined period.

10. An image display system, comprising:
shutter glasses, having a first active polarizer with a first polarization direction, wherein the first active polarizer determines the first polarization direction according to a display mode; and
a display apparatus, outputting an image, wherein the display apparatus comprises:
a second active polarizer, having a second polarization direction, wherein the second active polarizer determines the second polarization direction according to the display mode;
a liquid crystal layer;
a bottom polarizer having a third polarization direction; and
a backlight unit, generating a backlight, wherein the image is outputted by the backlight passing through the bottom polarizer, the liquid crystal layer, and the second active polarizer in order,
wherein when the display mode is a normal mode, the second polarization direction is perpendicular to the third polarization direction, and
wherein when the display mode is a safe mode, an included acute angle between the second polarization direction and the third polarization direction is smaller than an included acute angle between the first polarization direction and the second polarization direction.

11. The image display system of claim 10, wherein when the display mode is the safe mode, a sharpness of the image passing through the shutter glasses is clearer than a sharpness of the image.

12. The image display system of claim 10, wherein the display device further comprises:
a second ¼ wave-length phase plate having a second optical axis on a second direction, wherein the second active polarizer is arranged between the second ¼ wave-length phase plate and the liquid crystal layer.

13. The image display system of claim 12, wherein the shutter glasses further comprises:
a first ¼ wave-length phase plate having a first optical axis on a first direction, wherein the first direction is perpendicular to the second direction.

14. The image display system of claim 10, wherein the display apparatus further comprises a control unit generating a first deflection signal and a second deflection signal according to the display mode.

15. The image display system of claim 14, wherein the control unit is a keyboard controller determining the display mode according to an input via a user keyboard.

16. The image display system of claim 14, wherein the first active polarizer of the shutter glasses further receives the first deflection signal, and the first active polarizer determines the first polarization direction according to the first deflection signal.

17. The image display system of claim 14, wherein the second active polarizer of the display apparatus further receives the second deflection signal, and the second active polarizer determines the second polarization direction according to the second deflection signal.

18. The image display system of claim 14, wherein the control unit renews the first deflection signal and the second deflection signal in a predetermined period.
